(19) United States
(12) Patent Application Publication
(10) Pub. No.: US 2010/0012284 A1
(43) Pub. Date: Jan. 21, 2010

(54) METHOD FOR DETERMINING HYDROPHOBIC ORGANIC PARTICLES IN A PAPER STOCK

(75) Inventor: Hans-Peter Kaub, Altrip (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/527,509

(22) PCT Filed: Feb. 28, 2008
(86) PCT No.: PCT/EP2008/052400

§ 371 Date: Aug. 17, 2009

(30) Foreign Application Priority Data
Mar. 1, 2007 (EP) 07103345.0

(51) Int. Cl. G01N 21/64

(52) U.S. Cl. 162/49

(57) ABSTRACT

A method for determining the concentration of hydrophobic organic particles in the filtrate of a paper stock, wherein the hydrophobic organic particles are marked with a fluorescent dye, said particles are then excited to emit light, the light emitted by the marked particles is detected and the concentration by mass of the particles is determined from the fluorescence intensity, and use of the method for determining the total concentration of hydrophobic organic particles in the filtrate of a paper stock drained on a wire.

The invention relates to a method for determining hydrophobic organic particles in the filtrate of a paper stock.

In the production of paper, it is of interest, for example, to analyze contaminant particles in the paper stock with regard to their size distribution and amount. Contaminant particles are generally hydrophobic and tacky. They originate, for example, from recycled wastepaper and, in the papermaking process, lead to deposits in the machines. In order to suppress or to eliminate the adverse effect of the contaminants on the papermaking, fixing agents are metered into the paper stock. This ensures that contaminants are bound to the cellulose fibers and deposits in the machines are very substantially avoided. The amount of fixing agent required in each case is then determined with the aid of an analysis of the paper stock or of the white water for contaminant particles.

Various methods are known for determining the size distribution of contaminant particles in a paper stock. With conventional methods of investigation, for example X-ray microanalysis, infrared spectrophotometry or gel permeation chromatography, as reviewed in R. Wilken and J. Strauss, “Grundlegende Untersuchungen über klebende Verunreinigungen im wiederverwendeten Altpapier”, Mitteilungen aus dem Papiertechnischen Institut der Papiertechnischen Stiftung, volume 11-12 (1984), page 292 et seq., the type of contaminant particles, i.e. their chemical composition, can be determined in the laboratory. It is also possible to obtain qualitative information about concentration and particle size distribution. However, these methods all have the disadvantage that they are relatively time-consuming and labor-intensive and are therefore unsuitable for the direct monitoring of contaminant changes and the effect of additives on the binding of the contaminants to the paper stock during the production cycle.

Another method for determining the particle size distribution of contaminant particles is described in T. Kröhl, P. Lorencak, A. Gierulski, H. Eipel and D. Horn, “A new laser-optical method for counting colloidally dispersed pitch”, Nordic Pulp and Paper Research Journal, volume 9 (1994), no. 1, page 26 et seq. In this method, contaminant particles are stained with a fluorescent dye and isolated by hydrodynamic focusing. Thereafter, laser light is projected into the sample with the isolated contaminant particles and fluorescent light emitted by these is recorded. The particle size distribution can then be derived from the intensity of the fluorescence signals.

WO 92/11534 discloses a measuring method for determining the number and size or resin particles in a paper stock, a paper stock suspension first being prepared, the resin particles being separated therefrom by filtration, the resin particles being marked with a fluorescent dye, then isolated and caused to emit light by a citation, the light signals being detected and the signals being evaluated for counting and size determination of the resin particles. The fluorescent dye used is N-(n-butyl)-4-(n-butylamino)naphthalimide.

EP-A 0 856 731 discloses a method for determining size distribution of at least two particle types (A_{K}) of fluorescent particles (Tᵢ) in a single sample, the particles (Tᵢ) being isolated in the sample and light being projected into the sample along a predetermined projection direction,

at least one scattered light intensity value (S(Tᵢ)) and at least one fluorescent light intensity value (F(Tᵢ)) of each particle (Tᵢ) being measured,
the particles (Tᵢ) being coordinated in each case with a particle type (A_{K}) on the basis of the position of their pairs of values (S(Tᵢ), F(Tᵢ)) in a region (B_{K}) in a three-dimensional space (R), which is defined by the scattered light intensity values (S(Tᵢ)), the fluorescent light intensity values (F(Tᵢ)) and the frequency of the pairs of values (S(Tᵢ), F(Tᵢ)), each region (B_{K}) having at least one local maximum of the frequency of the pairs of values (S(Tᵢ), F(Tᵢ)) in the space (R) for the particle type (A_{K}),
the relative frequency of the fluorescent light intensity values (F(Tᵢ)) being determined for each particle type (A_{K}),
the relative particle size distribution being calculated for each particle type (A_{K}) from the relative frequency of the fluorescent light intensity values (F(Tᵢ)) for the corresponding particle type (A_{K}),
the relative particle size distributions for the individual particle types (A_{K}) being standardized relative to one another with the aid of the position of the regions (B_{K}) in the three-dimensional space (R) which is defined by the scattered light intensity values (S(Tᵢ)), the fluorescent light intensity values (F(Tᵢ)) and the frequency of the pairs of values (S(Tᵢ), F(Tᵢ)), and a common relative particle size distribution thus being formed for the particles (Tᵢ) of all particle types (A_{K}).

This method is used in particular for determining the particle size distribution of hydrophobic contaminant particles in paper stock or in white water of paper machines and is used for controlling the metering of fixing agents to the paper stock by producing a control signal corresponding to or coordinated with the common relative particle size distribution and carrying out the metering of the required amount of fixing agent on the basis of this control signal.

WO 06/122921 discloses a method for determining the size concentration, the particle size and the particle size distribution of natural and/or synthetic sizes in a paper stock, a sample which comprises size particles being stained with a fluorescent dye, the particles in the sample being isolated, light being projected in and the scattered light and/or fluorescent light emitted by the sample being detected and the signals received being evaluated. The method is used for determining the particle size distribution of reactive sizes in paper stock or in white water of paper machines during papermaking.

In the methods described above, the particles to be determined are always isolated. However, the counting of individual particles is complicated.

It is the object of the invention to provide another measuring method for determining the concentration by mass of hydrophobic particles in a filtrate of a paper stock.

The object is achieved, according to the invention, by a method for determining the concentration of hydrophobic organic particles in the filtrate of a paper stock, wherein the hydrophobic organic particles are marked with a fluorescent dye, said particles are then excited to emit light, the light emitted by the marked particles is detected and the concentration by mass of the particles is determined from the fluorescence intensity.

Hydrophobic organic particles are, for example, the finely divided contaminants present in a paper stock, such as stickies, white pitch and resin and size. The contaminants substantially comprise dispersed hydrophobic materials, which are, for example, residues of binders of paper coating slips or are adhesives. The particle size of the contaminants is, for example, from 0.5 to 100 μm.

Suitable sizes are natural and/or synthetic sizes, e.g. reactive size, rosin size, modified rosin sizes or polymer dispersions having a sizing effect. The sizes are compounds which are dispersed in water and, for example, have particle sizes in the range from 0.5 to 100 μm, preferably from 1 μm to 20 μm.

The most important reactive sizes for paper are alkyldiketenes (AKD) and alkenylsuccinic anhydrides. They are used as engine sizes in the production of paper, board and cardboard. These substances are substantially C₁₄- to C₂₂-alkyldiketenes, such as stearyidiketene, palmityidiketene, behenyldiketene, oleyidiketene and mixtures of the diketenes. They are prepared, for example, by emulsification in water in the presence of cationic starch and an anionic dispersant under the action of shear forces, cf. U.S. Pat. No. 3,223,544 and U.S. Pat. No. 3,130,118. Owing to an excess of cationic starch compared with the anionic dispersant, the AKD dispersions thus prepared have a cationic charge.

Alkyldiketenes can also be used together with other sizes. Thus, for example, WO 94/05855 discloses the dispersing of alkyldiketenes in a mixture of an aqueous suspension of a digested cationic starch and a finely divided aqueous polymer dispersion which is a size for paper. The resulting mixture is used as size for paper. In addition, aqueous, anionic AKD dispersions are known which are obtainable, for example, by dispersing AKD in water in the presence of anionic dispersants as the sole stabilizer, cf. WO 00/23651.

Polymer sizes are described, for example, in JP-A 58/115 196, EP-B 0 257 412 and EP-B 0 276 770. They are substantially aqueous dispersions of copolymers which are prepared in the presence of starch or degraded starch. Suitable copolymers are, for example, copolymers of styrene and/or acrylonitrile and acrylates.

Alkenylsuccinic anhydrides are likewise used in industry as engine sizes in the production of paper and paper products. Examples of such sizes are the isomeric 4-, 5-, 6-, 7-, and 8- hexadecenylsuccinic anhydrides, decenylsuccinic anhydride, octenylsuccinic anhydride, dodecenylsuccinic anhydride and n-hexadecenylsuccinic anhydride, cf. also C. E. Farley and R. B. Wasser, The Sizing of Paper, Second Edition, (3), Sizing With Alkenyl Succinic Anhydride, TAPPI PRESS, 1989, ISBN 0-89852-051-7.

Suitable natural sizes are rosin size and chemically modified rosin sizes, cf. E. Strazdins, Chapter 1, “Chemistry and Application of Rosin Size” in W. F. Reynolds (Ed.), “The Sizing of Paper”, Second Edition, Tappi Press (Atlanta, USA), 1989, pages 1 to 31 (ISBN 0-89852-051-7).

The measurements for the integral quantitative determination of hydrophobic particles are carried out, for example, in a fluorescence spectrophotometer. For the investigations, a spectrophotometer from Hitachi was used (Hitachi F4010). Clear samples having a low intrinsic absorbance are preferably measured in a 90° arrangement in which the excitation light is incident perpendicularly on the wall of the cell in which the sample to be investigated is present. The light emitted is measured at an angle of 90° to the excitation light. In order to investigate turbid solutions and dispersions, the front face arrangement is chosen, in which the excitation light strikes the cell at an angle of, for example, 45° and the reflected light is emitted at an angle of 90° to the excitation light from the sample and is analyzed. The reflected light is isolated.

The samples which comprise contaminants and/or a size are stained with at least one fluorescent dye. Examples of suitable dyes are:

N-(n-butyl)-4-(n-butylamino)naphthalimide (Fluorol 7GA),
dye of Color Index (C.I.) number 40662 (Celluflor),
dye of C.I. number 45400 (Eosin B),
3,3-ethoxydicarbocyanine iodide,
trisodium salt of 8-hydroxy-1,3,6-pyrenetrisulfonic acid,
6-nitro-1,3,3-trimethyl-[2H]-1-benzopyran-2,2-indole (Merocyanin 540), 2-[6-(diethylamino)-3-diethylimino-3H-xanthen-9-yl)benzoic acid (Rhodamine B).

A particularly preferably used fluorescent dye is N-(n-butyl)-4-(n-butylamino)naphthalimide.

Cellulose fibers and, if appropriate, inorganic pigments are also present in the filtrate of a paper stock. These substances are not stained by the fluorescent dyes, so that they do not interfere with the measurement. In order to mark the contaminants and the sizes with a fluorescent dye, an action time of, for example, from 2 to 14 minutes, preferably from 2 to 5 minutes, is required. In order to simplify the method of analysis and to obtain reproducible results, it is advantageous to specify a certain reaction time, for example 5 minutes, for the duration of dyeing.

A solution of at least one fluorescent dye in ethanol is preferably used for staining the samples to be investigated. The concentration of fluorescent dye which is dissolved in ethanol is, for example, from 10 to 40 mg/l. The concentration of contaminants and/or sizes is, for example, from 0 to 20 mg/l.

Investigations into various polymer particles (commercially available polymer dispersions which are known as binders for paper coating slips, e.g. Acronal® S360D and Styronal® D718, are used for this purpose) gave a linear relationship between the concentration by mass of polymer particles and the measured fluorescence intensity. In a concentration range from 0 to 0.1 g/l of contaminants and/or sizes, a quantitative mass analysis of contaminants and/or sizes can be carried out by the above-described marking with at least one fluorescent dye and with the aid of the determination of the fluorescence intensity of the particles thus marked. In the stated concentration range, there is in fact a linear relationship between the concentration by mass of polymer particles and the fluorescence intensity. In this way, a quantitative analysis of the total mass of polymer particles is rapidly obtained. However, a distinction between different polymer particles is not possible.

The measuring method according to the invention is suitable in particular for fast tests for determining the effectiveness of process chemicals. The measuring method is therefore used for determining the total concentration of hydrophobic organic particles in the filtrate of a paper stock drained on a wire. It is suitable in particular as an online measuring method in the papermaking process.

With the aid of this measuring method, it is possible, for example, to control the addition of contaminant control agents and/or sizes in the ongoing papermaking process. A known contaminant control agent is, for example, hydrolyzed polyvinylformamide having a degree of hydrolysis of, for example, from 60 to 95%. It is added as a fixing agent to the paper stock before sheet formation. If the white water is analyzed in an ongoing papermaking process, the concentration of contaminants can be determined therein with the aid of the measuring method according to the invention and the metering of the partly hydrolyzed polyvinylformamide to the paper stock can be adjusted so that the white water has as low a content of contaminants as possible. The contaminants are, for example, bound by the added partly hydrolyzed polyvinylformamide to the cellulose fibers.

### EXAMPLE

A sticky system comprising 8 g/l of TMP pulp and 0.16 g/l of Styronale D718 (aqueous dispersion of a binder based on styrene and butadiene) was prepared as a model substance by initially taking 500 ml of this mixture in a beaker and adding 5 ml of a hydrolyzed polyvinylformamide having a degree of hydrolysis of 83% and a K value of 61 as a fixing agent. The K value was determined according to H. Fikentscher, Cellulose-Chemie, volume 13, 58-64 and 71-74 (1932) in 5% strength aqueous sodium chloride solution at a temperature of 25° C. and a polymer concentration of 0.5% by weight. After the fixing agent had acted on the paper stock for 5 minutes, the mixture was drained in a dynamic drainage jar with sheet formation, the first 100 ml of the filtrate being collected. 1 ml of an ethanolic solution of the fluorescent dye N-(n-butyl)-4-(n-butylamino)naphthalimide (Fluorol® 7GA) was added to 25 ml of the filtrate, and the sample was thoroughly mixed and was investigated after a dyeing time of 5 minutes using a fluorescence spectrophotometer (Hitachi F4010) in a fronfface arrangement. The gap width of the excitation gap and of the emission gap was 5 nm. The incident light had a wavelength of 442 nm, and the fluorescence intensity was measured at 500 nm. The evaluation was effected on the basis of a previously recorded calibration curve for the corresponding sticky system for concentrations from 0 to 0.05 g/l of Styronal® D718. A concentration of 0.01 g/l of Styronal D718 was determined as the proportion of sticky in the filtrate. This value corresponds to a retention of Styronal® D718 on TMP pulp of 93.7%.

1. A method for determining the concentration of hydrophobic organic particles in the filtrate of a paper stock, wherein the hydrophobic organic particles are marked with a fluorescent dye, said particles are then excited to emit light, the light emitted by the marked particles is detected and the concentration by mass of the particles is determined from the fluorescence intensity.

2. The method according to claim 1, wherein the fluorescent dye used is N-(n-butyl)-4-(n-butylamino)naphthalimide.

3. The method according to claim 1 for determining the total concentration of hydrophobic organic particles in the filtrate of a paper stock drained on a wire.

4. The method according to claim 1 as an online measuring method in the papermaking process.

5. The method according to claim 4, wherein the measuring method is used for controlling the addition of contaminant control agents and/or sizes in the ongoing papermaking process.
